(19) United States
(12) Patent Application Publication
(10) Pub. No.: US 2008/0023214 A1
(43) Pub. Date: Jan. 31, 2008

(54) Flexible printed circuit cable and method of soldering the same to a printed circuit board

(75) Inventor: Peter Kuo, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/881,862

(22) Filed: Jul. 30, 2007

(30) Foreign Application Priority Data
Jul. 28, 2006 (CN) 200610041226.1

(51) Int. Cl. H01B 7/08

(52) U.S. Cl. 174/117 FF; 174/254; 439/357; 439/493

(57) ABSTRACT

A Flexible Printed Circuit Cable (FPC) (1) for being soldered to a Printed Circuit Board (PCB) (2), comprises a plurality of flat wires (11), a glue layer (12) attached to the wires and a pair of base boards (13) enclosing the flat wires and the glue layer, the base boards each has a removed part to expose both surfaces of a portion of each wire.

### BACKGROUND OF THE INVENTION

1. Field of the Invention

The present invention generally relates to a method of soldering a flexible printed circuit cable (FPC) or other similar cables, to solder a FPC to a printed circuit board (PCB).

2. Description of Prior Art

FPC is used in more and more fields cause of its pliability. Original FPC comprises a plurality of flat wires, a glue layer attached to the wires and a pair of boards enclosing the wires. When the FPC is to be soldered to a PCB, a part of the boards is removed to expose surfaces of the wires, and then spreading the soldering tin on the wires and pads of the PCB. Finally, the wires are soldered to corresponding pads by hot air fuse the soldering tin. CN patent No. 1725387 discloses a FPC comprising a plurality of wires sandwiched by a pair of boards. The top board is longer than the bottom board. The wires extend out of the bottom board and enclosed by top board. However, the effect or quality of soldering is difficult for visual inspection.

Hence, it is desirable to have an improved FPC to overcome the above-mentioned disadvantages of the prior art.

### BRIEF SUMMARY OF THE INVENTION

Accordingly, the object of the present invention is to provide a FPC that permits visual inspection of the effect of soldering.

In order to achieve the above-mentioned object, A Flexible Printed Circuit Cable (FPC) for being soldered to a Printed Circuit Board (PCB), comprises a plurality of flat wires, a glue layer attached to the wires and a pair of base boards enclosing the flat wires and the glue layer, the base boards each has a removed part to expose both surfaces of a portion of each wire.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of a FPC and a PCB in accordance with the present invention;

FIG. 2 is an exploded, perspective view of the FPC shown in FIG. 1;

FIG. 3 is a perspective view of a FPC and a PCB in another embodiment; and

FIG. 4 is an exploded, perspective view of the FPC shown in FIG. 3.

### DETAILED DESCRIPTION OF THE INVENTION

Reference will now be made to the drawing figures to describe the present invention in detail.

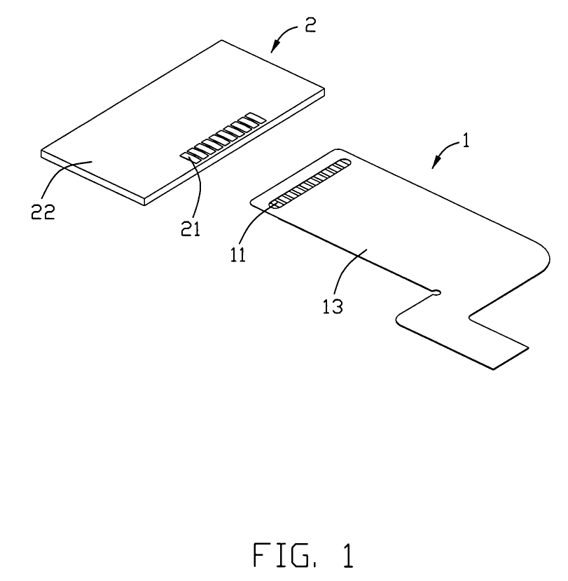

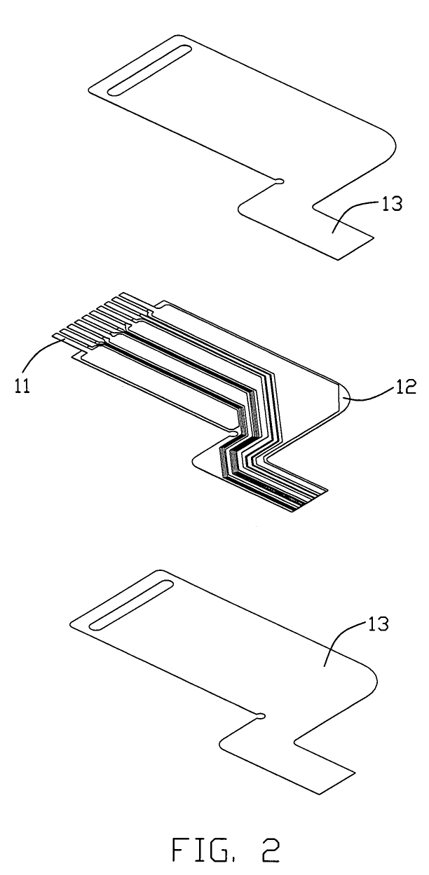

Referring to FIGS. 1 and 2, a Flexible Printed Circuit Board (FPC) 1 in accordance with the present invention comprises a pair of base boards 13, a glue layer 12, and a plurality of wires 11. The base boards 13 comprise an upper board and a lower boards. The glue layer 12 is attached the wires and sandwiched between the bottom board 13 and the wires. The wires 11 is made of copper and sandwiched between the upper board 13 and the glue layer 12. A printed circuit board (PCB) comprises a base plate 22 and a plurality of pads 21 forming on the base plate 22. The pads 21 are used for electrically connecting with the wires 11 of the FPC 1.

Before the FPC 1 is soldered to the PCB 2, a part of each base board 13 of FPC 1 is removed by the laser light, and forms a rectangular cutout on both the upper base board 13 and the lower base board 13. Accordingly, two surfaces of each wire 11 are disposed in the cutout. One surface of each wire 11 disposed in the cutout forms a soldering portion (not labeled). Both the pads 21 of the PCB 2 and the soldering portions of the wires 11 are spread by the soldering tin. During soldering, the soldering tin on the PCB 2 and the FPC 1 is fused with each other by the hot air for electrically connecting the pads 21 of the PCB 2 and the wires 11 of FPC 1. Thereby, we can directly judge the soldering effect through the surface of each wire 11 opposite to the soldering portion by eyeballing.

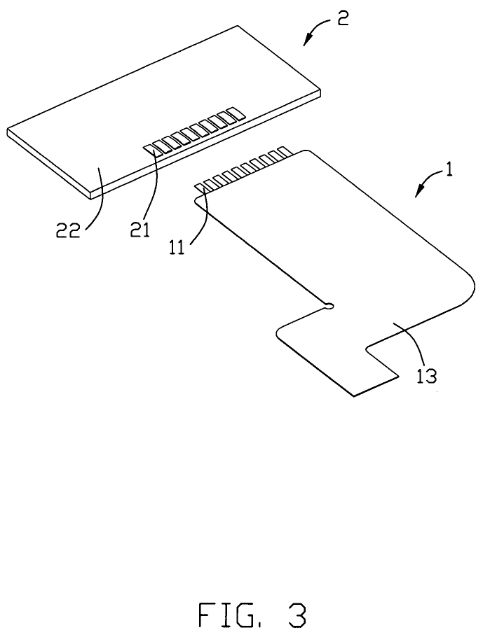

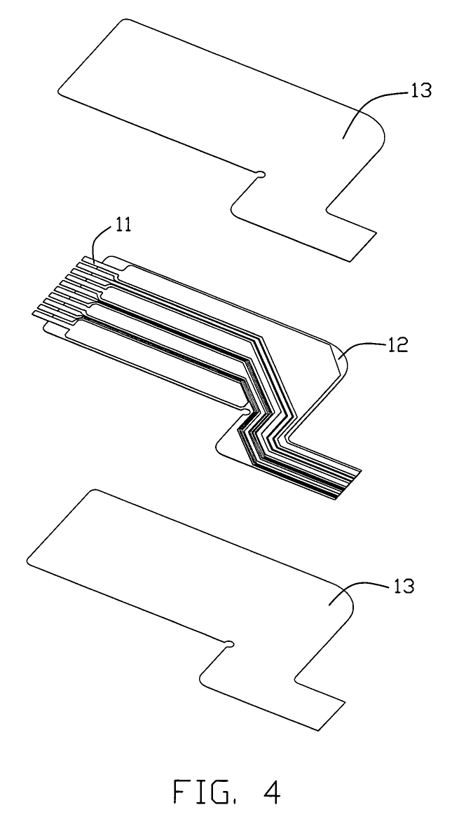

FIG. 3 and FIG. 4 disclose another embodiment. The wires 11 project out of a front end of the base boards 13 and the glue layer 12. Both the pads 21 of the PCB 2 and a first surface of the part of the wires 11 projecting out of the base boards 13 are spread by the soldering tin. During soldering, the soldering tin on the PCB 2 and the FPC 1 is fused with each other by the hot air for electrically connecting the pads 21 of the PCB 2 and the wires 11 of FPC 1. Thereby, we can directly judge the soldering effect through the second surface of wires 11 opposite to the first surface by visual inspection.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A Flexible Printed Circuit Cable (FPC) for being soldered to a Printed Circuit Board (PCB), comprising:
a plurality of flat wires;
a glue layer attached to the wires; and
a pair of base boards enclosing the flat wires and the glue layer, the base boards each having a removed part to expose both surfaces of a portion of each wire.

2. The FPC as claimed in claim 1, wherein the PCB comprises a plurality of pads soldered to corresponding wires of FPC.

3. The FPC as claimed in claim 1, wherein the exposed portions of the wires are disposed within an envelope of the base boards.

4. The FPC as claimed in claim 1, wherein the exposed portions of the wires are disposed out of the base boards.

5. The FPC as claimed in claim 4, wherein one surface of each wire disposed out of the base boards forms a soldering portion for soldering to a pad of the PCB.

6. The FPC as claimed in claim 5, wherein the soldering portions of the wires and the pads of the PCB are applied with solder prior to soldering.

7. The FPC as claimed in claim 6, wherein the solder is fused by hot air.

8. The FPC as claimed in claim 7, wherein the parts of the base boards are removed by laser beam.

9. A method of soldering a FPC to a PCB, comprising following steps of:
providing a FPC comprising a plurality of flat wires, a glue layer attached to the wires and a pair of base boards enclosing the wires and the glue layer, wherein the FPC is prepared by removing a corresponding part of each base board to expose both surfaces of each wire to form a soldering portion;
providing a PCB comprising a plurality of pads;
spreading solder to the pads of the PCB and the soldering portion of each wire; and
fusing the solder on the pads and the soldering portions to solder the FPC to the PCB.

10. An electrical assembly comprising:
a printed circuit board;
a plurality of electrical pads formed on one surface of said printed circuit board;
a flexible thin cable including first and second insulative layers oppositely sandwiching therebetween a plurality conductors extending along a front-to-back direction;
some portions of the first layers being removed to form a slot while a front portion of the first layer being kept to segregate said slot from an exterior in said front-to-back direction, said slot exposing corresponding sections of the conductors while still maintaining sufficient portions substantially located in both front and rear sides of said exposed sections for providing sufficient strength thereabouts to protect said exposed sections; wherein
said exposed sections are soldered to the corresponding electrical pad under a condition said first face intimately faces the surface of the printed circuit board.

11. The electrical connector assembly as claimed in claim 10, wherein said some portions of the second layer are removed corresponding to the removed portions of the first layer so as to expose said slot in a vertical direction so as to permit inspection of soldering between the exposed sections of the conductors and the corresponding electrical pads.

12. The electrical connector assembly as claimed in claim 10, wherein said slot is also closed in both transverse ends.

13. The electrical connector assembly as claimed in claim 10, wherein said flexible thin cable is a flexible printed circuit cable.
